(19) United States
(12) Patent Application Publication
(10) Pub. No.: US 2021/0407415 A1
(43) Pub. Date: Dec. 30, 2021

(54) PIXEL DRIVING CIRCUIT AND DISPLAY DEVICE

(71) Applicant: Wuhan China Star Optoelectronics Semiconductor Display Technology Co., Ltd., Wuhan (CN)

(72) Inventor: Xueshun HOU, Wuhan (CN)

(73) Assignee: Wuhan China Star Optoelectronics Semiconductor Display Technology Co., Ltd., Wuhan (CN)

(21) Appl. No.: 16/754,766

(22) PCT Filed: Nov. 22, 2019
(86) PCT No.: PCT/CN2019/120391

§ 371 Date: Apr. 9, 2020

(30) Foreign Application Priority Data
Nov. 13, 2019 (CN) 201911108630.X

(51) Int. Cl. G09G 3/3258; G09G 3/3266; G09G 3/3275; G09G 3/00

(52) U.S. Cl. CPC G09G 3/3258; G09G 3/3266; G09G 2310/08; G09G 3/007; G09G 2310/061; G09G 3/3275

(57) ABSTRACT

A pixel driving circuit and a display device are disclosed. A voltage writing module writes a compensation voltage into a driving module. A resetting module provides a predetermined voltage to the driving module and a resetting voltage to the resetting module in a resetting stage. The driving module controls the light emitting module to generate light according to the predetermined voltage. Because the voltage writing module could write the compensation voltage to the driving module, this prevents the threshold voltage of the driving module from shifting. During the resetting stage, the voltage level of the driving module is reset to the predetermined voltage. The source of the driving module is reset to the resetting voltage. The resetting voltage and the predetermined voltage are different. This reduces the shift of the threshold voltage of the TFT in the driving module caused by the leakage current and thus raises the display quality.

### FIELD OF THE INVENTION

The present invention relates to a display technique, and more particularly, to a pixel driving circuit and a display device.

### BACKGROUND OF THE INVENTION

Organic light emitting diode (OLED) display has a wide color gamut, high contrast, low power consumption and flexibility and thus is more competitive than other types of displays. Specifically, the active-matrix OLED (AMOLED) technique has become very important for flexible displays.

Conventionally, the structure of the pixel driving circuit is simple and has many defects. For example, the thin film transistor (TFT) is driven by a positive voltage for a long time, this makes threshold voltage shift. In addition, since the development trend of the display is to have higher definition and higher driving frequency, the pixel driving circuit needs to have a higher pixel resolution and refreshing frequency. This makes the threshold voltage shift more and thus affects the display quality of the OLED display.

### SUMMARY OF THE INVENTION

One objective of an embodiment of the present invention is to provide a pixel driving circuit and a display device, capable of compensating the threshold voltage of the TFTs in the driving module to suppress the threshold voltage shift and to raise the display quality.

According to an embodiment of the present invention, a pixel driving circuit is disclosed. The pixel driving circuit comprises: a light emitting module; a driving module, electrically connected to the light emitting module, configured to control the light emitting module to generate light according to a predetermined voltage; a voltage writing module, having an input end and an output end, configured to write a compensation voltage to the driving module; wherein the input end of the voltage writing module has a signal input interface, and the output end of the voltage writing module is electrically connected to the driving module and the light emitting module; a resetting module having two ends respectively electrically connected to the driving module and the light emitting module, configured to providing the predetermined voltage to the driving module and a resetting voltage to the light emitting module in a resetting stage of the pixel driving module; and an electronic characteristic recovery module, having one end electrically connected to the driving module and another end receiving a light emitting control signal; wherein the predetermined voltage and the resetting voltage are different and are both negative.

Furthermore, the driving module comprises:

a first thin film transistor (TFT), having a source, a drain and a gate, wherein the source is electrically connected to the electronic characteristic recovery module, the drain is electrically connected to the light emitting module and the electronic characteristic recovery module, and the gate is electrically connected to the resetting module and the voltage writing module; and

a capacitor; having one end receiving a positive voltage source and another end electrically connected to the gate of the first TFT.

Furthermore, the voltage driving module comprises:

a second TFT, having a gate receiving a scan signal, a source receiving a data signal and a drain electrically connected to the gate of the first TFT; and

a third TFT, having a gate receiving the scan signal;

wherein the second TFT is a switch transistor, and the third TFT is positioned between the gate and the drain of the first TFT.

Furthermore, the electronic characteristic recovery module comprises:

a fifth TFT, having a source electrically connected to the positive voltage source, a drain electrically connected to the source of the first TFT, and a gate; and

a sixth TFT, having a source electrically connected to the drain of the first TFT, a drain electrically connected to the light emitting module, and a gate;

wherein the gate of the fifth TFT and the gate of the sixth TFT both receive the light emitting control signal to control emitting time of the light emitting module.

Furthermore, the resetting module comprises:

a fourth TFT, having a drain electrically connected to the gate of the first TFT, a source receiving the predetermined voltage, and a gate receiving a resetting signal; and

a seventh TFT, having a source electrically connected to an input end of the light emitting module, a drain electrically connected to an output end of the light emitting module and receiving a power signal, and a gate writing the resetting voltage into the gate of the first TFT through receiving the resetting signal.

Furthermore, the fourth TFT is a first dual-gate transistor and the third TFT is a second dual-gate transistor;

wherein the first dual-gate transistor comprises a first source transistor and a first drain transistor, the first source transistor and the first drain transistor respectively comprise a gate, a source and a drain, the source of the first source transistor is electrically connected to the predetermined voltage, the drain of the first source transistor is electrically connected to the source of the first drain transistor, and the drain of the first drain transistor is electrically connected to the gate of the first TFT; and

wherein the second dual-gate transistor comprises a second source transistor and a second drain transistor, the second source transistor and the second drain transistor respectively comprise a gate, a source and a drain, the source of the second source transistor is electrically connected to the drain of the first TFT, the drain of the second source transistor is electrically connected to the source of the second drain transistor and the drain of the drain transistor is electrically connected to the gate of the first TFT.

Furthermore, the light emitting module comprises a plurality of light emitting diodes connected in parallel, anodes of the light emitting diodes are electrically connected to the drain of the sixth TFT, and cathodes of the light emitting diodes receive a power signal.

Furthermore, the pixel driving circuit has a resetting stage, a data signal writing and threshold voltage compensation stage, and a light emitting stage;

wherein when the pixel driving circuit is in the resetting stage, the driving module and the resetting module are turned on, and the electronic characteristic recovery module, the voltage writing module and the light emitting module are turned off;

wherein when the pixel driving circuit is in the data writing and threshold voltage compensation stage, the driving module and the voltage writing module are turned on, and the electronic characteristic recovery module, the resetting module and the light emitting module are turned off; and

wherein when the pixel driving circuit is in the light emitting stage, the driving module, the electronic characteristic recovery module and the light emitting module are turned on, and the voltage writing module and the resetting module are turned off.

Furthermore, the first TFT, the second TFT, the third TFT, the fourth TFT, the fifth TFT, the sixth TFT and the seventh TFT are all P-type TFTs;

wherein the light emitting control signal and the scan signal correspond to a high voltage level and the electronic characteristic recovery control signal corresponds to a low voltage level in the resetting stage;

wherein the light emitting control signal corresponds to the high voltage level and the electronic characteristic recovery control signal and the scan signal correspond to the low voltage level in the data writing and threshold voltage compensation stage; and

wherein the electronic characteristic recovery control signal and the scan signal correspond to the high voltage level and the light emitting control signal corresponds to the low voltage level in the light emitting stage.

According to an embodiment of the present invention, a display device is disclosed. The display device comprises a timing controller and the above-mentioned pixel driving circuit. The timing controller is configured to control a light emitting control signal, a scan signal and an electronic characteristic recovery control signal.

In contrast to the conventional art, an embodiment of the present invention provides a pixel driving circuit and a display device. The pixel driving circuit comprises a driving module, a voltage writing module, an electronic characteristic recovery module, a resetting module and a light emitting module. The voltage writing module is used to write a compensation voltage into the driving module. The resetting module is used to provide a predetermined voltage to the driving module and a resetting voltage to the resetting module in a resetting stage. The driving module is used to control the light emitting module to generate light according to the predetermined voltage. Because the voltage writing module could write the compensation voltage to the driving module, this could prevent the threshold voltage of the driving module from shifting. Furthermore, when the pixel driving circuit is in the resetting stage, the voltage level of the driving module is reset to the predetermined voltage. The source of the driving module is reset to the resetting voltage. Here, the resetting voltage and the predetermined voltage are different and are not positive values. This could reduce the shift of the threshold voltage of the TFT in the driving module caused by the leakage current and thus raises the display quality.

These and other features, aspects and advantages of the present disclosure will become understood with reference to the following description, appended claims and accompanying figures.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a diagram of a conventional pixel driving circuit.

FIG. 2 is a diagram of a pixel driving circuit according to an embodiment of the present invention.

FIG. 3 is a diagram of a pixel driving circuit according to another embodiment of the present invention.

FIG. 4 is a diagram of a pixel driving circuit according to another embodiment of the present invention.

FIG. 5 is a diagram of a pixel driving circuit according to another embodiment of the present invention.

FIG. 6 is a diagram of a pixel driving circuit according to another embodiment of the present invention.

FIG. 7 is a diagram of a pixel driving circuit according to another embodiment of the present invention.

FIG. 8 is a diagram of a pixel driving circuit according to another embodiment of the present invention.

FIG. 9 is a timing diagram of a pixel driving circuit according to an embodiment of the present invention.

### DETAILED DESCRIPTION OF PREFERRED EMBODIMENTS

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

In the description of this specification, the description of the terms “one embodiment”, “some embodiments”, “examples”, “specific examples”, or “some examples”, and the like, means to refer to the specific feature, structure, material or characteristic described in connection with the embodiments or examples being included in at least one embodiment or example of the present disclosure. In the present specification, the term of the above schematic representation is not necessary for the same embodiment or example. Furthermore, the specific feature, structure, material, or characteristic described may be in combination in a suitable manner in any one or more of the embodiments or examples. In addition, it will be apparent to those skilled in the art that different embodiments or examples described in this specification, as well as features of different embodiments or examples, may be combined without contradictory circumstances.

The terminology used herein is for the purpose of describing particular embodiments only and is not intended to be limiting of the invention. As used herein, the singular forms “a”, “said” and “the” are intended to include the plural forms as well, unless the context clearly indicates otherwise. It will be understood that the term “and/or,” when used in this specification, specify one or more associated elements, alone or in combination, are provided. It will be further understood that the terms “first,” “second,” “third,” and “fourth,” when used in this specification, claim and drawings, are used to distinguish different objects, rather than to describe a specific order. It will be further understood that the terms “comprises” and/or “comprising,” when used in this specification, specify the presence of stated features, products, steps, operations, elements, and/or components, but do not preclude the presence or addition of one or more other features, products, steps, operations, elements, components, and/or groups thereof.

The present disclosure provides a pixel driving circuit and a display device as introduced in the following paragraphs.

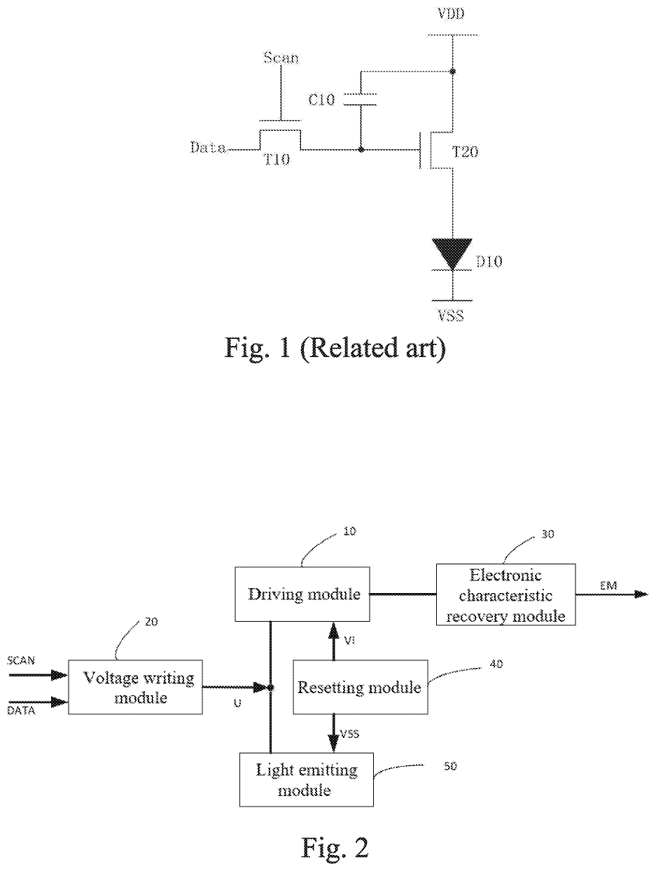

Please refer to FIG. 1. FIG. 1 is a diagram of a conventional pixel driving circuit. The pixel driving circuit is a 2T1C pixel driving circuit for an AMOLED display. The pixel driving circuit comprises a first TFT T10, a second TFT T20 and a capacitor C10. The first TFT T10 is a switch TFT. The second TFT T20 is a driving TFT. The capacitor C10 is a storage capacitor. Specifically, the gate of the first TFT T10 receives the scan signal Scan, the source of the first TFT T10 receives a data signal Data, the drain of the first TFT T10 is electrically connected to the gate of the second TFT T20 and one end of the capacitor C10. The source of the second TFT T20 is electrically connected to the positive voltage source VDD and the drain of the second TFT T20 is electrically connected the anode of the OLED D10. The cathode of the OLED D10 is electrically connected to the negative voltage source VSS. One end of the capacitor C10 is electrically connected to the drain of the first TFT T10 and the other end of the capacitor C10 is electrically connected to the source of the second TFT T20. When the AMOLED displays, the scan signal Scan turns on the first TFT T10 and the data signal Data enters the gate of the second TFT T20 and the capacitor C10 through the first TFT T10. Then, the first TFT T10 is cut off. Due to the storage effect of the capacitor C10, the gate voltage of the second TFT T20 could maintain its voltage level to be the same as the voltage of the data signal. The second TFT T20 maintains the conductive condition such that the driving current could pass through the second TFT T20 to the OLED D10 to drive the OLED D10 to generate light.

However, the structure of the pixel driving circuit shown in FIG. 1 is too simple and thus has more defects. For example, the second TFT T20 is driven by a positive voltage for a long time, this makes threshold voltage shift. In addition, since the development trend of the display is to have higher definition and higher driving frequency, the pixel driving circuit needs to have a higher pixel resolution and refreshing frequency. This makes the threshold voltage shift more and thus affects the display quality of the OLED display.

In order to solve the above-mentioned threshold voltage shift issue, a pixel driving circuit is disclosed. Please refer to FIG. 2. FIG. 2 is a diagram of a pixel driving circuit according to an embodiment of the present invention. As shown in FIG. 2, the pixel driving circuit comprises a driving module 10, a voltage writing module 20, an electronic characteristic recovery module 30, a resetting module 40 and a light emitting module 50.

The driving module 10 is electrically connected to the light emitting module 50. One end of the electronic characteristic recovery module 30 is electrically connected to the light emitting module 50 and the other end of the electronic characteristic recovery module 30 receives the light emitting signal EM. The voltage writing module 20 is electrically connected to the driving module 10 and the light emitting module 50. The voltage writing module 20 has the interface for receiving the scan signal SCAN and the data signal DATA. The two ends of the resetting module 40 are respectively electrically connected to the driving module 10 and the light emitting module 50.

The voltage writing module 20 is used to write the compensation voltage U into the driving module 10. The resetting module 40 is used to provide the predetermined voltage V1 to the driving module and provide the voltage signal VSS to the light emitting module when the pixel driving circuit is in a resetting stage. The driving module 10 is used to control the light emitting module 50 to generate light according to the predetermined voltage V1. In this embodiment, the predetermined voltage V1 and the voltage signal VSS are not equal and are both not positive values.

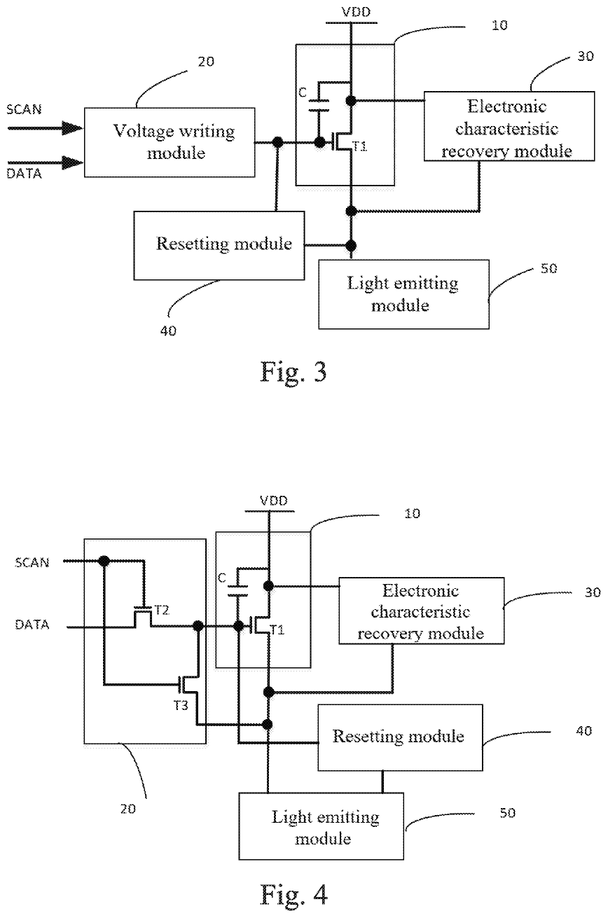

Please refer to FIG. 3. FIG. 3 is a diagram of a pixel driving circuit according to another embodiment of the present invention. The driving module 10 comprises a first TFT T1 and a capacitor C.

The first TFT T1 is a switch transistor. The source of the first TFT T1 is electrically connected to the electronic characteristic recovery module 30, the drain of the first TFT T1 is electrically connected to the light emitting module 50 and the electronic characteristic recovery module 30, and the gate of the first TFT T1 is electrically connected to the resetting module 40 and the voltage writing module 20.

One end of the capacitor C receives the positive voltage source VDD and the other end of the capacitor C is electrically connected to the gate of the first TFT T1.

Please refer to FIG. 4. FIG. 4 is a diagram of a pixel driving circuit according to another embodiment of the present invention. The voltage writing module 30 comprises a second TFT T2 and a third TFT T3. The second TFT T2 is a switch transistor.

The gate of the second TFT T2 receives the scan signal SCAN. The source of the second TFT T2 receives the data signal DATA. The drain of the second TFT T2 is electrically connected to the gate of the first TFT T1.

The third TFT T3 is positioned between the gate and the drain of the first TFT T1. The gate of the third TFT T3 receives the scan signal SCAN.

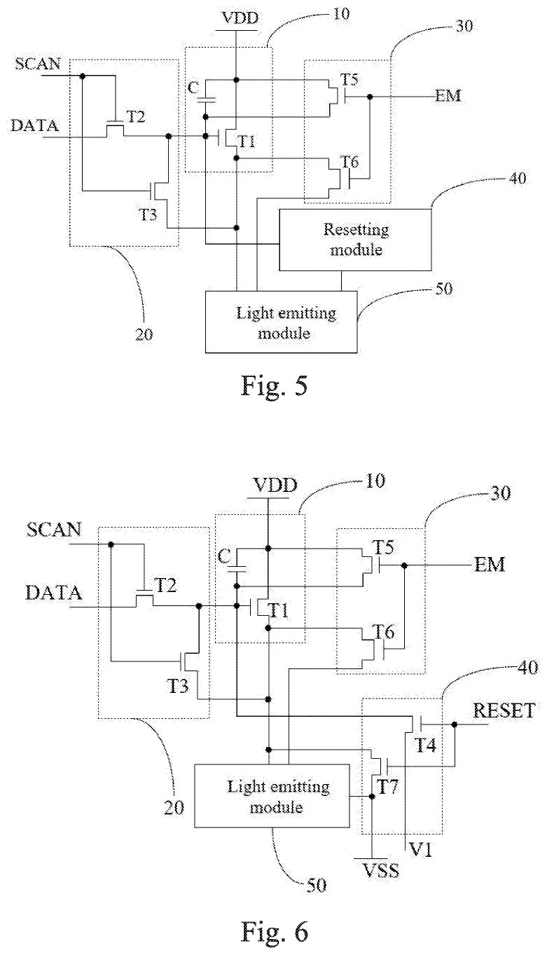

In some embodiments, please refer to FIG. 5. FIG. 5 is a diagram of a pixel driving circuit according to another embodiment of the present invention. As shown in FIG. 5, the electronic characteristic recovery module 30 comprises a fifth TFT T5 and a sixth TFT T6.

The source of the fifth TFT T5 is electrically connected to the positive voltage source VDD. The drain of the fifth TFT T5 is electrically connected to the source of the first TFT T1.

The source of the sixth TFT T6 is electrically connected to the drain of the first TFTT1. The drain of the sixth TFT T6 is electrically connected to the light emitting module 50.

The gate of the fifth TFT T5 and the gate of the sixth TFT T6 both receive the light emitting control signal EM to control the light emitting time of the light emitting module 50.

Please refer to FIG. 6. FIG. 6 is a diagram of a pixel driving circuit according to another embodiment of the present invention. The resetting module 40 receives the resetting signal RESET. The resetting module 40 comprises a fourth TFT T4 and a seventh TFT T7.

The drain of the fourth TFT T4 is electrically connected to the gate of the first TFT T1. The source of the fourth TFT T4 receives the predetermined voltage V1. The gate of the fourth TFT T4 receives the resetting signal RESET.

The source of the seventh TFT T7 is electrically connected to the input end of the light emitting module 50. The drain of the seventh TFT T7 is electrically connected to the output end of the light emitting module 50. The gate of the seventh TFT T7 writes the voltage signal VSS to the gate of the first TFT T1 through receiving the resetting signal RESET.

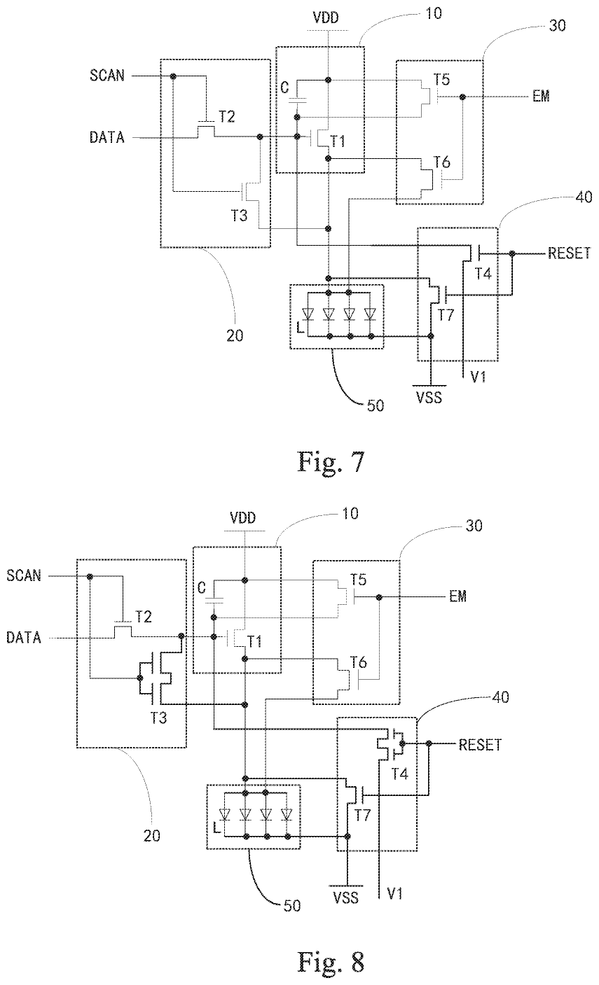

Please refer to FIG. 7. FIG. 7 is a diagram of a pixel driving circuit according to another embodiment of the present invention. As shown in FIG. 7, the light emitting module 50 comprises a plurality of light emitting diodes (LED) L connected in parallel. The anodes of the LEDs L are electrically connected to the drain of the sixth TFT T6. The cathodes of the LEDs receive the voltage signal VSS.

Please refer to FIG. 8. FIG. 8 is a diagram of a pixel driving circuit according to another embodiment of the present invention. As shown in FIG. 8, the fourth TFT T4 is a first dual-gate transistor and the third TFT T3 is a second dual-gate transistor.

The first dual-gate transistor comprises a first source transistor and a first drain transistor. The first source transistor and the first drain transistor respectively comprise a gate, a source and a drain. The source of the first source transistor is electrically connected to the predetermined voltage V1. The drain of the first source transistor is electrically connected to the source of the first drain transistor. The drain of the first drain transistor is electrically connected to the gate of the first TFT T1.

The second dual-gate transistor comprises a second source transistor and a second drain transistor. The second source transistor and the second drain transistor respectively comprise a gate, a source and a drain. The source of the second source transistor is electrically connected to the drain of the first TFT T1. The drain of the second source transistor is electrically connected to the source of the second drain transistor and the drain of the drain transistor is electrically connected to the gate of the first TFT T1.

Each of the first TFT T1, the second TFT T2, the third TFT T3, the fourth TFT T4, the fifth TFT T5, the sixth TFT T6 and the seventh TFT T7 could be nay one type of low temperature poly-silicon (LTPS) TFT, semiconductor oxide TFT, or amorphous TFT.

The pixel driving circuit has a resetting stage TA, a data signal writing and threshold voltage compensation stage TB, and a light emitting stage TC.

When the pixel driving circuit is in the resetting stage TA, the driving module 10 and the resetting module 40 are turned on, and the electronic characteristic recovery module 30, the voltage writing module 20 and the light emitting module 50 are turned off.

When the pixel driving circuit is in the data writing and threshold voltage compensation stage TB, the driving module 10 and the voltage writing module 20 are turned on, and the electronic characteristic recovery module 30, the resetting module 40 and the light emitting module 50 are turned off.

When the pixel driving circuit is in the light emitting stage TC, the driving module 10, the electronic characteristic recovery module 30 and the light emitting module 50 are turned on, and the voltage writing module 20 and the resetting module 40 are turned off.

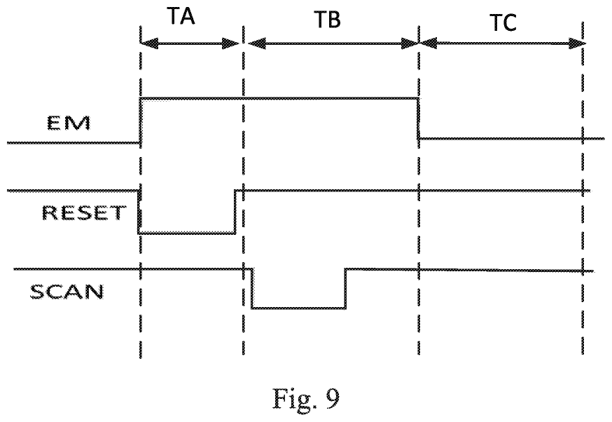

Specifically, please refer to FIG. 9. FIG. 9 is a timing diagram of a pixel driving circuit according to an embodiment of the present invention. The TFTs could be classified as N-type TFTs and P-type TFTs.

In this embodiment, the first TFT T1, the second TFT T2, the third TFT T3, the fourth TFT T4, the fifth TFT T5, the sixth TFT T6 and the seventh TFT T7 could be all P-type TFTs.

In this case, when the pixel driving circuit is in the resetting stage TA, the light emitting control signal EM and the scan signal SCAN correspond to a high voltage level and the electronic characteristic recovery control signal RESET corresponds to a low voltage level.

Furthermore, when the pixel driving circuit is in the data writing and threshold voltage compensation stage TB, the light emitting control signal EM corresponds to the high voltage level and the electronic characteristic recovery control signal RESET and the scan signal SCAN correspond to the low voltage level.

When the pixel driving circuit is in the light emitting stage TC, the electronic characteristic recovery control signal RESET and the scan signal SCAN correspond to the high voltage level and the light emitting control signal EM corresponds to the low voltage level.

Or, in this embodiment, the first TFT T1, the second TFT T2, the third TFT T3, the fourth TFT T4, the fifth TFT T5, the sixth TFT T6 and the seventh TFT T7 could be all N-type TFTs.

In this case, when the pixel driving circuit is in the resetting stage TA, the light emitting control signal EM and the scan signal SCAN correspond to the low voltage level and the electronic characteristic recovery control signal RESET corresponds to the high voltage level.

Furthermore, when the pixel driving circuit is in the data writing and threshold voltage compensation stage TB, the light emitting control signal EM corresponds to the low voltage level and the electronic characteristic recovery control signal RESET and the scan signal SCAN correspond to the high voltage level.

When the pixel driving circuit is in the light emitting stage TC, the electronic characteristic recovery control signal RESET and the scan signal SCAN correspond to the low voltage level and the light emitting control signal EM corresponds to the high voltage level.

In addition, in the pixel driving circuit, the light emitting control signal EM, the scan signal SCAN and the electronic characteristic recovery control signal RESET are all generated by an external timing controller.

In addition to the above-mentioned pixel driving circuit, a pixel driving method is disclosed. The pixel driving method comprises following four steps:

Step 1: Provide a pixel driving circuit.

The pixel driving circuit comprises a driving module, a voltage writing module, an electronic characteristic recovery module, a resetting module and a light emitting module.

The driving module is electrically connected to the light emitting module. The driving module is used to control the light emitting module to generate light.

The voltage writing module receives the scan signal and the data signal and is electrically connected to the driving module and light emitting module. The voltage writing module is used to write the compensation voltage to the driving module.

One end of the electronic characteristic recovery module is electrically connected to the driving module. The other end of the electronic characteristic recovery module receives the light emitting control signal to make the driving module control the light emitting time of the light emitting module.

The two ends of the resetting module are respectively electrically connected to the driving module and the light emitting module. The resetting module is used to provide the predetermined voltage to the driving module and provide the resetting voltage to the light emitting module. In addition, the resetting voltage and the predetermined voltage are not the same and are not positive values.

Step 2: Enter the resetting stage.

The light emitting control signal and the scan signal correspond to the first voltage level and the electronic characteristic recovery control signal corresponds to the second voltage level.

The driving module and the resetting module are tuned on. The electronic characteristic recovery module, the voltage writing module and the light emitting module are turned off. The voltage level of the driving module is reset to the predetermined voltage and the voltage level of the light emitting module is reset to the resetting voltage.

Step 3: Enter the data writing and threshold voltage compensation stage.

The light emitting control signal corresponds to the first voltage level and the electronic characteristic recovery control signal and the scan signal correspond to the second voltage level.

At this stage, the driving module and the voltage writing module are tuned on. The electronic characteristic recovery module, the resetting module and the light emitting module are turned off. The driving module stores the compensation voltage of the voltage writing module.

Step 4: Enter the light emitting stage.

The electronic characteristic recovery control signal and the scan signal correspond to the first voltage level and the light emitting control signal corresponds to the second voltage level.

At this stage, the driving module, the electronic characteristic recovery module and the light emitting module are tuned on. The voltage writing module and the resetting module are turned off.

The driving module sends currents to the light emitting module to drive the light emitting module to generate light.

Furthermore, the first TFT, second TFT, third TFT, fourth TFT, fifth TFT, sixth TFT and seventh TFT are N-type TFTs or P-type TFTs.

Upon a condition that the first TFT, second TFT, third TFT, fourth TFT, fifth TFT, sixth TFT and seventh TFT are N-type TFTs, the first voltage level indicates a high voltage level, and the second voltage level indicates a low voltage level.

Upon a condition that the first TFT, second TFT, third TFT, fourth TFT, fifth TFT, sixth TFT and seventh TFT are P-type TFTs, the first voltage level indicates a low voltage level, and the second voltage level indicates a high voltage level.

Based on the same concept, a display device is disclosed. The display device comprises a timing controller and the above-mentioned pixel driving circuit. The timing controller is used to control/generate the light emitting control signal, the scan signal and the electronic characteristic recovery signal in the pixel driving circuit.

In addition, based on the same concept, a display panel is disclosed. The display panel could comprise the above-mentioned pixel driving circuit. The display panel could be used in a cell phone, a TV, a display, a tablet, a laptop, a digital frame, a navigator or any other products or components having displaying functions.

### INDUSTRIAL APPLICABILITY

In sum, an embodiment of the present invention provides a pixel driving circuit and a display device. The pixel driving circuit comprises a driving module, a voltage writing module, an electronic characteristic recovery module, a resetting module and a light emitting module. The voltage writing module is used to write a compensation voltage into the driving module. The resetting module is used to provide a predetermined voltage to the driving module and a resetting voltage to the resetting module in a resetting stage. The driving module is used to control the light emitting module to generate light according to the predetermined voltage. Because the voltage writing module could write the compensation voltage to the driving module, this could prevent the threshold voltage of the driving module from shifting. Furthermore, when the pixel driving circuit is in the resetting stage, the voltage level of the driving module is reset to the predetermined voltage. The source of the driving module is reset to the resetting voltage. Here, the resetting voltage and the predetermined voltage are different and are not positive values. This could reduce the shift of the threshold voltage of the TFT in the driving module caused by the leakage current and thus raises the display quality.

Above are embodiments of the present invention, which does not limit the scope of the present invention. Any modifications, equivalent replacements or improvements within the spirit and principles of the embodiment described above should be covered by the protected scope of the invention.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

1. A pixel driving circuit comprising:
a light emitting module;
a driving module, electrically connected to the light emitting module, configured to control the light emitting module to generate light according to a predetermined voltage;
a voltage writing module, having an input end and an output end, configured to write a compensation voltage to the driving module; wherein the input end of the voltage writing module has a signal input interface, and the output end of the voltage writing module is electrically connected to the driving module and the light emitting module;
a resetting module having two ends respectively electrically connected to the driving module and the light emitting module, configured to providing the predetermined voltage to the driving module and a resetting voltage to the light emitting module in a resetting stage of the pixel driving module; and
an electronic characteristic recovery module, having one end electrically connected to the driving module and another end receiving a light emitting control signal;
wherein the predetermined voltage and the resetting voltage are different and are both negative.

2. The pixel driving circuit of claim 1, wherein the driving module comprises:
a first thin film transistor (TFT), having a source, a drain and a gate, wherein the source is electrically connected to the electronic characteristic recovery module, the drain is electrically connected to the light emitting module and the electronic characteristic recovery module, and the gate is electrically connected to the resetting module and the voltage writing module; and
a capacitor; having one end receiving a positive voltage source and another end electrically connected to the gate of the first TFT.

3. The pixel driving circuit of claim 2, wherein the voltage driving module comprises:
a second TFT, having a gate receiving a scan signal, a source receiving a data signal and a drain electrically connected to the gate of the first TFT; and
a third TFT, having a gate receiving the scan signal;
wherein the second TFT is a switch transistor, and the third TFT is positioned between the gate and the drain of the first TFT.

4. The pixel driving circuit of claim 3, wherein the electronic characteristic recovery module comprises:
a fifth TFT, having a source electrically connected to the positive voltage source, a drain electrically connected to the source of the first TFT, and a gate; and
a sixth TFT, having a source electrically connected to the drain of the first TFT, a drain electrically connected to the light emitting module, and a gate;
wherein the gate of the fifth TFT and the gate of the sixth TFT both receive the light emitting control signal to control emitting time of the light emitting module.

5. The pixel driving circuit of claim 4, wherein the resetting module comprises:
a fourth TFT, having a drain electrically connected to the gate of the first TFT, a source receiving the predetermined voltage, and a gate receiving a resetting signal; and
a seventh TFT, having a source electrically connected to an input end of the light emitting module, a drain electrically connected to an output end of the light emitting module and receiving a power signal, and a gate writing the resetting voltage into the gate of the first TFT through receiving the resetting signal.

6. The pixel driving circuit of claim 5, wherein the fourth TFT is a first dual-gate transistor and the third TFT is a second dual-gate transistor;
wherein the first dual-gate transistor comprises a first source transistor and a first drain transistor, the first source transistor and the first drain transistor respectively comprise a gate, a source and a drain, the source of the first source transistor is electrically connected to the predetermined voltage, the drain of the first source transistor is electrically connected to the source of the first drain transistor, and the drain of the first drain transistor is electrically connected to the gate of the first TFT; and
wherein the second dual-gate transistor comprises a second source transistor and a second drain transistor, the second source transistor and the second drain transistor respectively comprise a gate, a source and a drain, the source of the second source transistor is electrically connected to the drain of the first TFT, the drain of the second source transistor is electrically connected to the source of the second drain transistor and the drain of the second drain transistor is electrically connected to the gate of the first TFT.

7. The pixel driving circuit of claim 5, wherein the light emitting module comprises a plurality of light emitting diodes connected in parallel, anodes of the light emitting diodes are electrically connected to the drain of the sixth TFT, and cathodes of the light emitting diodes receive a power signal.

8. The pixel driving circuit of claim 1, wherein the pixel driving circuit has a resetting stage, a data signal writing and threshold voltage compensation stage, and a light emitting stage;
wherein when the pixel driving circuit is in the resetting stage, the driving module and the resetting module are turned on, and the electronic characteristic recovery module, the voltage writing module and the light emitting module are turned off;
wherein when the pixel driving circuit is in the data writing and threshold voltage compensation stage, the driving module and the voltage writing module are turned on, and the electronic characteristic recovery module, the resetting module and the light emitting module are turned off; and
wherein when the pixel driving circuit is in the light emitting stage, the driving module, the electronic characteristic recovery module and the light emitting module are turned on, and the voltage writing module and the resetting module are turned off.

9. The pixel driving circuit of claim 8, wherein the first TFT, the second TFT, the third TFT, the fourth TFT, the fifth TFT, the sixth TFT and the seventh TFT are all P-type TFTs;
wherein the light emitting control signal and the scan signal correspond to a high voltage level and the electronic characteristic recovery control signal corresponds to a low voltage level in the resetting stage;
wherein the light emitting control signal corresponds to the high voltage level and the electronic characteristic recovery control signal and the scan signal correspond to the low voltage level in the data writing and threshold voltage compensation stage; and
wherein the electronic characteristic recovery control signal and the scan signal correspond to the high voltage level and the light emitting control signal corresponds to the low voltage level in the light emitting stage.

10. A display device, comprising:
a timing controller, configured to control the light emitting control signal, a scan signal and an electronic characteristic recovery control signal; and
a pixel driving circuit, comprising:
a light emitting module;
a driving module, electrically connected to the light emitting module, configured to control the light emitting module to generate light according to a predetermined voltage;
a voltage writing module, having an input end and an output end, configured to write a compensation voltage to the driving module; wherein the input end of the voltage writing module has a signal input interface, and the output end of the voltage writing module is electrically connected to the driving module and the light emitting module;
a resetting module having two ends respectively electrically connected to the driving module and the light emitting module, configured to providing the predetermined voltage to the driving module and a resetting voltage to the light emitting module in a resetting stage of the pixel driving module; and
an electronic characteristic recovery module, having one end electrically connected to the driving module and another end receiving a light emitting control signal;
wherein the predetermined voltage and the resetting voltage are different and are both negative.

11. The display device of claim 10, wherein the driving module comprises:
a first thin film transistor (TFT), having a source, a drain and a gate, wherein the source is electrically connected to the electronic characteristic recovery module, the drain is electrically connected to the light emitting module and the electronic characteristic recovery module, and the gate is electrically connected to the resetting module and the voltage writing module; and
a capacitor; having one end receiving a positive voltage source and another end electrically connected to the gate of the first TFT.

12. The display device of claim 11, wherein the voltage driving module comprises:
a second TFT, having a gate receiving a scan signal, a source receiving a data signal and a drain electrically connected to the gate of the first TFT; and
a third TFT, having a gate receiving the scan signal;
wherein the second TFT is a switch transistor, and the third TFT is positioned between the gate and the drain of the first TFT.

13. The display device of claim 12, wherein the electronic characteristic recovery module comprises:
a fifth TFT, having a source electrically connected to the positive voltage source, a drain electrically connected to the source of the first TFT, and a gate; and
a sixth TFT, having a source electrically connected to the drain of the first TFT, a drain electrically connected to the light emitting module, and a gate;
wherein the gate of the fifth TFT and the gate of the sixth TFT both receive the light emitting control signal to control emitting time of the light emitting module.

14. The display device of claim 13, wherein the resetting module comprises:
a fourth TFT, having a drain electrically connected to the gate of the first TFT, a source receiving the predetermined voltage, and a gate receiving a resetting signal; and
a seventh TFT, having a source electrically connected to an input end of the light emitting module, a drain electrically connected to an output end of the light emitting module and receiving a power signal, and a gate writing the resetting voltage into the gate of the first TFT through receiving the resetting signal.

15. The display device of claim 14, wherein the fourth TFT is a first dual-gate transistor and the third TFT is a second dual-gate transistor;
wherein the first dual-gate transistor comprises a first source transistor and a first drain transistor, the first source transistor and the first drain transistor respectively comprise a gate, a source and a drain, the source of the first source transistor is electrically connected to the predetermined voltage, the drain of the first source transistor is electrically connected to the source of the first drain transistor, and the drain of the first drain transistor is electrically connected to the gate of the first TFT; and
wherein the second dual-gate transistor comprises a second source transistor and a second drain transistor, the second source transistor and the second drain transistor respectively comprise a gate, a source and a drain, the source of the second source transistor is electrically connected to the drain of the first TFT, the drain of the second source transistor is electrically connected to the source of the second drain transistor and the drain of the second drain transistor is electrically connected to the gate of the first TFT.

16. The display device of claim 14, wherein the light emitting module comprises a plurality of light emitting diodes connected in parallel, anodes of the light emitting diodes are electrically connected to the drain of the sixth TFT, and cathodes of the light emitting diodes receive a power signal.

17. The display device of claim 10, wherein the pixel driving circuit has a resetting stage, a data signal writing and threshold voltage compensation stage, and a light emitting stage;
wherein when the pixel driving circuit is in the resetting stage, the driving module and the resetting module are turned on, and the electronic characteristic recovery module, the voltage writing module and the light emitting module are turned off;
wherein when the pixel driving circuit is in the data writing and threshold voltage compensation stage, the driving module and the voltage writing module are turned on, and the electronic characteristic recovery module, the resetting module and the light emitting module are turned off; and
wherein when the pixel driving circuit is in the light emitting stage, the driving module, the electronic characteristic recovery module and the light emitting module are turned on, and the voltage writing module and the resetting module are turned off.

18. The display device of claim 17, wherein the first TFT, the second TFT, the third TFT, the fourth TFT, the fifth TFT, the sixth TFT and the seventh TFT are all P-type TFTs;
wherein the light emitting control signal and the scan signal correspond to a high voltage level and the electronic characteristic recovery control signal corresponds to a low voltage level in the resetting stage;
wherein the light emitting control signal corresponds to the high voltage level and the electronic characteristic recovery control signal and the scan signal correspond to the low voltage level in the data writing and threshold voltage compensation stage; and
wherein the electronic characteristic recovery control signal and the scan signal correspond to the high voltage level and the light emitting control signal corresponds to the low voltage level in the light emitting stage.
